(19) United States
(12) Patent Application Publication
(10) Pub. No.: US 2026/0295697 A1
(43) Pub. Date: Oct. 1, 2026

(54) MACHINE TOOL, CONTROL METHOD, AND CONTROL PROGRAM

(71) Applicant: DMG MORI CO., LTD., NARA (JP)

(72) Inventors: Eugen WOELK, NARA (JP); Hiroya ISHIYAMA, NARA (JP); Minoru TANEMOTO, NARA (JP)

(73) Assignee: DMG MORI CO., LTD., NARA (JP)

(21) Appl. No.: 19/560,832

(22) Filed: Mar. 9, 2026

(30) Foreign Application Priority Data
Mar. 27, 2025 (JP) 2025-053985

(51) Int. Cl. B23F 1/04; B23F 23/12

(52) U.S. Cl. CPC B23F 1/04; B23F 23/1287

(57) ABSTRACT

[Problem to be Solved] To provide a technology for improving the accuracy of gear cutting.

[Solution] A machine tool includes a workpiece spindle, a tool holding portion configured to be able to hold a pinion cutter, a first rotation drive unit that drives the workpiece spindle to rotate about a first axis extending along an axial direction of the workpiece spindle, a feed drive unit that moves the tool holding portion, a second rotation drive unit that drives the tool holding portion to rotate about a second axis extending along the axial direction of the pinion cutter, a first brake mechanism that brakes rotation of the workpiece spindle, a second brake mechanism that brakes rotation of the tool holding portion, and a control unit. The control unit executes reciprocating drive processing for driving the tool holding portion to reciprocate along the first axis, and adjustment processing for rotating the workpiece spindle a predetermined angle about the first axis and rotating the tool holding portion a predetermined angle about the second axis. The reciprocating drive processing is executed while braking is applied by the first and second brake mechanisms. The adjustment processing is performed while no braking is applied.

### BACKGROUND

### Field of Invention

### Technical Field

The present disclosure relates to a machine tool, a control method, and a control program.

### BACKGROUND ART

### Background Art

Conventionally, gear machining has been performed using a dedicated machine with a pinion cutter. In this regard, JP 2000-190127A (Patent Document 1) discloses a technology for adding a gear shaping function using a pinion cutter to a machining function of a machining center (paragraph [0007]).

The machining center disclosed in Patent Document 1 includes a table that can be driven in an X-axis direction and a Y-axis direction, and a tool spindle that can be driven in a Z-axis direction. A workpiece is fixed to the table. This machining center achieves gear cutting by causing the tool spindle to undergo reciprocating motion in the Z-axis direction while synchronizing relative circular interpolation motion of the pinion cutter attached to the tool spindle and the workpiece.

### CITATION LIST

### Patent Document

Patent Document 1: JP 2000-190127A

### SUMMARY

### Summary of Invention

### Technical Problem

The machining center disclosed in Patent Document 1 turns the pinion cutter about a C axis at a rotation speed of n, while controlling the driving of the table in the X-axis direction and the Y-axis direction such that the tool spindle revolves relatively about the workpiece, on a circle with a radius of (m·z1+m·z2)/2 (paragraph [0018]). That is, the machining center achieves gear cutting while constantly driving the tool spindle about the C-axis at a constant speed.

However, since the pinion cutter is subjected to cutting resistance while performing gear cutting on the workpiece, it is difficult to maintain a constant rotational speed of the tool spindle while performing gear cutting. As a result, the machining center disclosed in Patent Document 1 cannot sufficiently improve the accuracy of gear cutting.

Accordingly, there is a demand for a technology for improving the accuracy of gear cutting in a machine tool having a tool holding portion capable of feed driving.

### Solution to Problem

In one example of the present disclosure, a machine tool is provided. The machine tool includes: a workpiece spindle configured to hold a workpiece; a tool holding portion configured to hold a pinion cutter; a first rotation drive unit configured to drive the workpiece spindle to rotate about a first axis extending along an axial direction of the workpiece spindle; a feed drive unit configured to move the tool holding portion; a second rotation drive unit configured to drive the tool holding portion to rotate about a second axis extending along an axial direction of the pinion cutter; a first brake mechanism configured to brake rotation of the workpiece spindle; a second brake mechanism configured to brake rotation of the tool holding portion; and a control unit configured to control the feed drive unit, the first and second rotation drive units, and the first and second brake mechanisms. The control unit executes reciprocating drive processing for performing gear cutting on an inner peripheral surface or an outer peripheral surface of the workpiece by driving the tool holding portion to reciprocate along the first axis, and adjustment processing for adjusting a rotation angle between the workpiece spindle and the tool holding portion by rotating the workpiece spindle by a predetermined angle about the first axis and rotating the tool holding portion by a predetermined angle about the second axis. The reciprocating drive processing is executed while braking by the first brake mechanism and braking by the second brake mechanism are applied. The adjustment processing is executed while neither braking by the first brake mechanism nor braking by the second brake mechanism is applied.

In one example of the present disclosure, the control unit monitors a temperature of a drive system associated with the feed drive unit, and executes abnormality handling processing if the temperature exceeds a second threshold value.

In one example of the present disclosure, the abnormality handling processing includes at least one of processing for stopping gear cutting of the workpiece and processing for outputting a warning.

In one example of the present disclosure, the control unit executes processing for stopping execution of the abnormality handling processing in a case where the temperature falls below a first threshold value.

In one example of the present disclosure, the control unit executes the reciprocating drive processing and the adjustment processing further based on a preset parameter. The parameter includes a parameter for designating whether or not braking by the first brake mechanism is enabled. If the parameter is set to enable braking by the first brake mechanism, the control unit executes the reciprocating drive processing while enabling the braking, and if the parameter is set to disable braking by the first brake mechanism, the control unit executes the reciprocating drive processing while maintaining a rotation angle of the workpiece spindle at a target rotation angle corresponding to a command value with the braking disabled.

In one example of the present disclosure, in the reciprocating drive processing, the tool holding portion is driven to reciprocate between a first position along the first axis and a second position along the first axis. The first position is a position that is a first distance away from a surface on one side of the workpiece along the first axis. The second position is a position that is a second distance away from a surface on another side of the workpiece along the first axis.

In one example of the present disclosure, the control unit executes the reciprocating drive processing further based on a preset parameter. The parameter includes the first distance and the second distance.

In one example of the present disclosure, the control unit executes the adjustment processing further based on a preset parameter. The parameter includes a correction value associated with a rotation center of the tool holding portion during the adjustment processing.

In one example of the present disclosure, the control unit executes the reciprocating drive processing further based on a preset parameter. The parameter includes a parameter for designating whether or not a feed drive direction of the tool holding portion during gear cutting of the workpiece is to be inclined in a cutting direction of cutting into the workpiece.

In another example of the present disclosure, in a control method for a machine tool, the machine tool includes: a workpiece spindle configured to hold a workpiece; a tool holding portion configured to hold a pinion cutter; a first rotation drive unit configured to drive the workpiece spindle to rotate about a first axis extending along an axial direction of the workpiece spindle; a feed drive unit configured to move the tool holding portion; a second rotation drive unit configured to drive the tool holding portion to rotate about a second axis extending along an axial direction of the pinion cutter; a first brake mechanism configured to brake rotation of the workpiece spindle; a second brake mechanism configured to brake rotation of the tool holding portion; and a control unit configured to control the feed drive unit, the first and second rotation drive units, and the first and second brake mechanisms. In the control method, the control unit executes a reciprocating driving step of driving the tool holding portion to reciprocate along the first axis to perform gear cutting on an inner peripheral surface of the workpiece or an outer peripheral surface of the workpiece; and an adjusting step of adjusting a rotation angle between the workpiece spindle and the tool holding portion by rotating the workpiece spindle by a predetermined angle about the first axis and rotating the tool holding portion by a predetermined angle about the second axis. The reciprocating driving step is executed while braking by the first brake mechanism and braking by the second brake mechanism are applied. The adjusting step is executed while neither braking by the first brake mechanism nor braking by the second brake mechanism is applied.

In another example of the present disclosure, in a control program for a machine tool, the machine tool includes: a workpiece spindle configured to be able to hold a workpiece; a tool holding portion configured to hold a pinion cutter; a first rotation drive unit configured to drive the workpiece spindle to rotate about a first axis extending along an axial direction of the workpiece spindle; a feed drive unit configured to move the tool holding portion; a second rotation drive unit configured to drive the tool holding portion to rotate about a second axis extending along an axial direction of the pinion cutter; a first brake mechanism configured to brake rotation of the workpiece spindle; a second brake mechanism configured to brake rotation of the tool holding portion; and a control unit configured to control the feed drive unit, the first and second rotation drive units, and the first and second brake mechanisms. In the control program, the control unit executes reciprocating drive processing for performing gear cutting on an inner peripheral surface or an outer peripheral surface of the workpiece by driving the tool holding portion to reciprocate along the first axis, and adjustment processing for adjusting a rotation angle between the workpiece spindle and the tool holding portion by rotating the workpiece spindle by a predetermined angle about the first axis and rotating the tool holding portion by a predetermined angle about the second axis. The reciprocating drive processing is executed while braking by the first brake mechanism and braking by the second brake mechanism are applied. The adjustment processing is executed while neither braking by the first brake mechanism nor braking by the second brake mechanism is applied.

The above and other objects, features, aspects, and advantages of the present invention will become apparent from the following detailed description of the present invention as understood in connection with the accompanying drawings.

### BRIEF DESCRIPTION OF DRAWINGS

FIG. 1 is a diagram showing an external appearance of a machine tool.

FIG. 2 is a diagram illustrating an example of a device configuration of the machine tool.

FIG. 3 is a diagram illustrating an example of a drive mechanism of the machine tool.

FIG. 4 is a diagram illustrating an example of a hardware configuration of a control unit.

FIG. 5 is a diagram illustrating a pinion cutter performing gear cutting on a workpiece.

FIG. 6 is a diagram showing a processing mode in a C-XY mode from a Z-axis direction.

FIG. 7 is a diagram showing the processing mode in the C-XY mode from an X-axis direction.

FIG. 8 is a diagram showing a processing mode in a C-CE mode from a Z-axis direction.

FIG. 9 is a diagram for describing reciprocating drive processing of the tool spindle during gear cutting.

FIG. 10 is a diagram showing a pinion cutter being feed-driven obliquely.

FIG. 11 is a flowchart showing a flow of machining processing in the C-XY mode.

FIG. 12 is a diagram schematically showing a flow of machining processing in the C-XY mode.

FIG. 13 is a flowchart showing a flow of machining processing in the C-CE mode.

FIG. 14 is a diagram schematically showing a flow of a machining mode in the C-CE mode.

FIG. 15 is a diagram showing a machining mode in the C-XY mode according to a modified example, from the Z-axis direction.

### DETAILED DESCRIPTION OF PREFERRED EMBODIMENTS

### Description of Embodiments

Hereinafter, embodiments according to the present invention will be described with reference to the drawings. In the following description, the same members and constituent components are denoted by the same reference numerals. They also have the same names and functions. Accordingly, redundant descriptions thereof will not be repeated. Note that the embodiments and modifications described herein may be selectively combined with each other as appropriate.

### A. Machine Tool 100

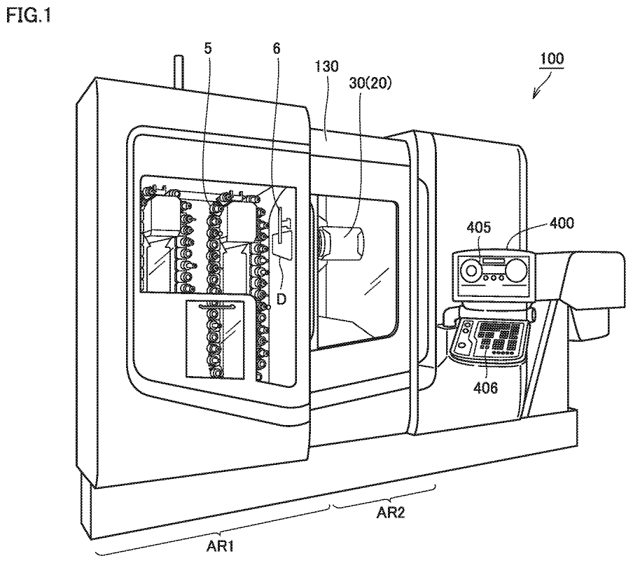

First, with reference to FIG. 1, a machine tool 100 according to a first embodiment will be described. FIG. 1 is a diagram showing an external appearance of the machine tool 100.

The term “machine tool” used in the present specification is a concept that encompasses various devices that have a function of machining a workpiece. The machine tool 100 may be a horizontal machining center or a vertical machining center. Alternatively, the machine tool 100 may be a cutting machine, a grinding machine, a composite machining device, a five-axis machining device, or the like. Also, the machine tool 100 is not limited to a machine tool that performs only subtractive machining. The machine tool 100 may also perform additive machining in addition to subtractive machining.

The machine tool 100 has a tool storage area AR1 and a machining area AR2. The tool storage area AR1 and the machining area AR2 are partitioned by a cover 130.

A magazine 5 and an ATC (Automatic Tool Changer) 6 are provided in the tool storage area AR1. A tool spindle 30, which is an example of a tool holding portion 20, is provided in the machining area AR2.

The tool spindle 30 uses at least one of a plurality of tools held in the magazine 5 to machine a workpiece. More specifically, the machine tool 100 drives the magazine 5 to move a tool corresponding to a machining process (hereinafter also referred to as the “next tool to be used”) to a first tool exchange position. In addition, the machine tool 100 drives the tool spindle 30 to move the tool attached to the tool spindle 30 (hereinafter also referred to as a “used tool”) to a second tool exchange position. Thereafter, the ATC 6 exchanges the next tool to be used, which is waiting at the first tool exchange position, with the used tool, which is waiting at the second tool exchange position. Tools are exchanged through a door D provided in a partition between the machining area AR2 and the tool storage area AR1. The door D is a sliding door that is opened and closed by a drive source such as a motor. Thereafter, the tool spindle 30 machines the workpiece using the next tool to be used that is attached to the tool spindle 30.

Also, the machine tool 100 is provided with an operation panel 400. The operation panel 400 includes a display 405 for displaying various types of information related to machining, and operation keys 406 for accepting various operations on the machine tool 100.

### B. Device Configuration of Machine Tool 100

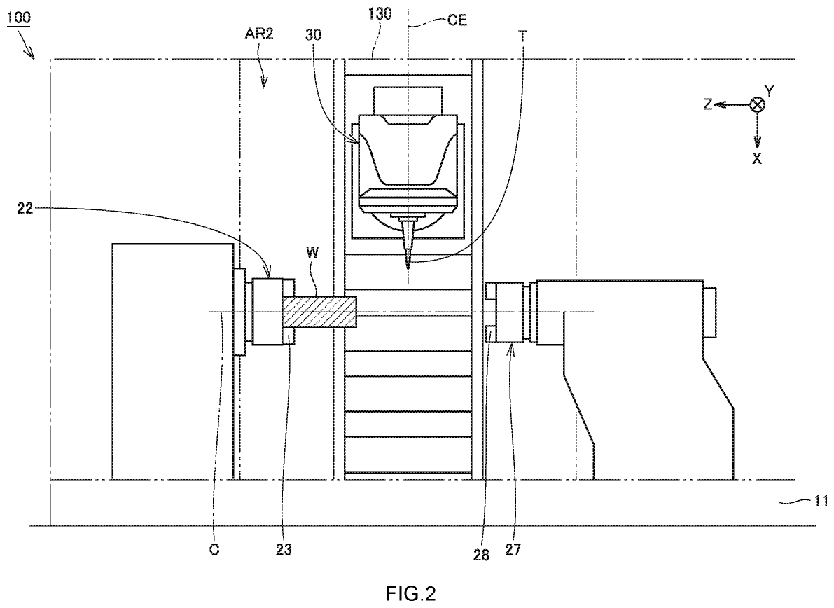

Next, a device configuration of the machine tool 100 will be described with reference to FIG. 2. FIG. 2 is a diagram showing an example of the device configuration of the machine tool 100.

The machine tool 100 includes a bed 11, a workpiece spindle 22, an opposing workpiece spindle 27, and the tool spindle 30.

Hereinafter, a direction parallel to a rotation axis direction of the workpiece spindle 22 will also be referred to as a “Z-axis direction” for the sake of convenience in the description. In addition, a direction on a horizontal plane orthogonal to the Z-axis direction is also referred to as a “Y-axis direction”. A direction orthogonal to both the Y-axis direction and the Z-axis direction is referred to as an “X-axis direction”. In the example of FIG. 2, the X-axis direction corresponds to the direction of gravity.

Furthermore, the direction along the rotation axis direction of the workpiece spindle 22 is referred to as a “rotation axis C” (first axis). The rotation axis Cis parallel to the Z-axis direction and is also the rotation axis of the opposing workpiece spindle 27. In addition, the direction along the rotation axis direction of the tool spindle 30 is referred to as a “rotation axis CE” (second axis). The rotation axis CE of the tool spindle 30 is also the rotation axis of the tool T attached to the tool spindle 30. The direction of the rotation axis CE changes as the tool spindle 30 is pivoted.

The bed 11 is a base member for supporting various devices provided inside the machine tool 100. In the example of FIG. 2, the bed 11 supports the workpiece spindle 22, the opposing workpiece spindle 27, and the tool spindle 30. The bed 11 is installed on the floor of a factory or the like. The bed 11 is made of a metal such as cast iron.

The workpiece spindle 22 is configured to be rotatable while holding the workpiece W. More specifically, the workpiece spindle 22 is provided with a first chuck mechanism 23. The first chuck mechanism 23 is a mechanism for fixing the workpiece W to the workpiece spindle 22. The workpiece spindle 22 is configured to be rotatable about the rotation axis C.

The opposing workpiece spindle 27 rotates the workpiece W while supporting the workpiece W from the side opposite to the workpiece spindle 22. More specifically, the opposing workpiece spindle 27 is configured to be movable in the Z-axis direction by various drive mechanisms such as a motor, and can support the workpiece W from the side opposite to the workpiece spindle 22. In addition, the opposing workpiece spindle 27 is provided with a second chuck mechanism 28. The second chuck mechanism 28 is a mechanism for fixing the workpiece W to the opposing workpiece spindle 27. Furthermore, the opposing workpiece spindle 27 is configured to be rotatable about the rotation axis C.

The tool spindle 30 is provided at a higher position than the workpiece spindle 22 and the opposing workpiece spindle 27. The tool spindle 30 is configured to be able to hold a tool T, and holds the tool spindle 30 rotatably about the rotation axis CE. The tool spindle 30 is configured to be movable in the X-axis direction, the Y-axis direction, and the Z-axis direction by various driving mechanisms such as a motor. The tool spindle 30 is configured to be capable of pivoting by various driving mechanisms such as a motor. As an example, the tool spindle 30 is configured to be rotatable about a B axis centered in the Y axis direction.

Various types of tools T can be attached to the tool spindle 30 depending on the machining mode. The tool T is attached to the tool spindle 30 by the ATC 6 described above. The tool spindle 30 performs cutting by bringing the tool T into contact with the workpiece W fixed to the workpiece spindle 22. As an example, the tool Tis a pinion cutter TC, which will be described later. The tool T serving as a pinion cutter performs gear cutting on the outer peripheral surface or inner peripheral surface of the workpiece W to form a gear. The pinion cutter TC is stored in, for example, the magazine 5. When performing gear cutting on the workpiece W, the machine tool 100 calls up a pinion cutter TC stored in the magazine 5 and attaches the pinion cutter TC to the tool spindle 30 via the ATC 6.

### C. Drive Mechanism for Machine Tool 100

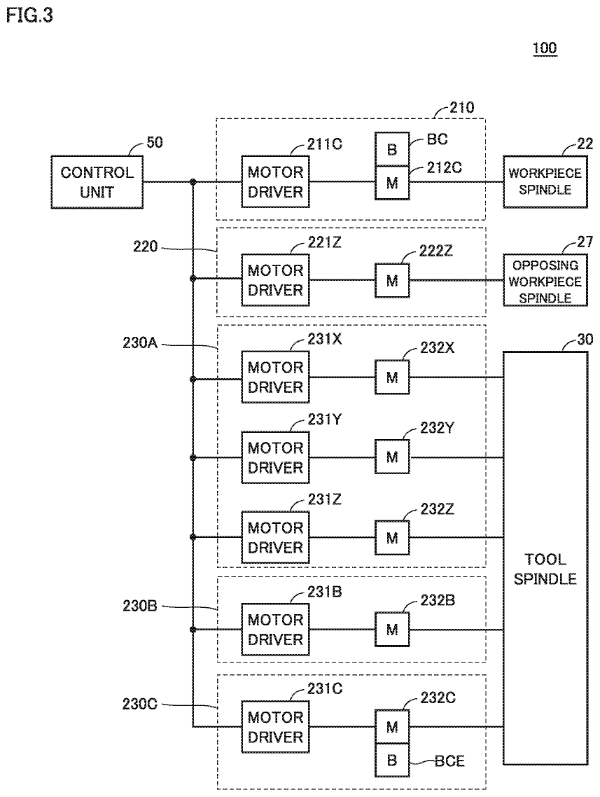

Next, a drive mechanism in the machine tool 100 will be described with reference to FIG. 3. FIG. 3 is a diagram showing an example of the drive mechanism of the machine tool 100.

As shown in FIG. 3, the machine tool 100 includes the above-described workpiece spindle 22, the above-described opposing workpiece spindle 27, the above-described tool spindle 30, a control unit 50, a rotation drive unit 210 (first rotation drive unit), a feed drive unit 220, a feed drive unit 230A, a rotation drive unit 230B (third rotation drive unit), and a rotation drive unit 230C (second rotation drive unit).

The control unit 50 controls the various devices that constitute the machine tool 100. As an example, the control unit 50 controls the rotation drive unit 210, the feed drive unit 220, the feed drive unit 230A, the rotation drive unit 230B, and the rotation drive unit 230C. Furthermore, the control unit 50 controls brake mechanisms (e.g., brake mechanisms BC and BCE described below) for various drive mechanisms of the machine tool 100.

The control unit 50 may have any device configuration. The control unit 50 may be configured as a single control unit, or may be configured as a plurality of control units. As an example, the control unit 50 includes at least one of CNC (Computer Numerical Control) and a PLC (Programmable Logic Controller).

The rotation drive unit 210 is a drive mechanism for driving the workpiece spindle 22 to rotate about the rotation axis C (see FIG. 2). In the example of FIG. 3, the rotation drive unit 210 is constituted by a motor driver 211C, a motor 212C, and the brake mechanism BC.

The motor driver 211C sequentially receives input of a target rotation angle or target rotation speed of the workpiece spindle 22 from the control unit 50, and outputs a current corresponding to the target rotation angle or the target rotation speed to the motor 212C. As a result, the workpiece held by the workpiece spindle 22 rotates about the rotation axis C. The motor 212C may be an AC motor, a stepping motor, a servo motor, or another type of motor.

The motor 212C is provided with the brake mechanism BC for braking the rotation of the workpiece spindle 22 about the rotation axis C. The brake mechanism BC is, for example, an electromagnetic brake, an electromagnetic clutch, or another hardware mechanism capable of preventing the rotational driving of the motor 212C. The control unit 50 outputs a control command to the brake mechanism BC to control clamping/unclamping of the rotation shaft of the motor 212C. As an example, the control unit 50 clamps the rotating shaft of the motor 212C by outputting an ON command to the brake mechanism BC, and unclamps the rotating shaft of the motor 212C by outputting an OFF command to the brake mechanism BC.

The feed drive unit 220 is a drive mechanism for feed-driving the opposing workpiece spindle 27. The feed drive unit 220 may be constituted by a single drive unit or a plurality of drive units. In the example in FIG. 3, the feed drive unit 220 is constituted by a motor driver 221Z and a motor 222Z.

The motor driver 221Z successively receives, from the control unit 50, input of a target position of the opposing workpiece spindle 27, and outputs a current corresponding to the target position to the motor 222Z. Accordingly, the motor 222Z moves the opposing workpiece spindle 27 to a certain position in the Z direction. The motor 222Z may be an AC motor, a stepping motor, a servo motor, or another type of motor.

The feed drive unit 230A is a drive mechanism for moving the tool spindle 30. The feed drive unit 230A may be constituted by a single drive unit or a plurality of drive units. In the example in FIG. 3, the feed drive unit 230A is constituted by motor drivers 231X to 231Z and motors 232X to 232Z.

The motor driver 231X successively receives, from the control unit 50, input of a target position in the X-axis direction of the tool spindle 30, and outputs a current corresponding to the target position to the motor 232X. Accordingly, the motor 232X drives the tool spindle 30 to a certain position in the X direction. The motor 232X may be an AC motor, a stepping motor, a servo motor, or another type of motor.

The motor driver 231Y successively receives, from the control unit 50, input of a target position in the Y-axis direction of the tool spindle 30, and outputs a current corresponding to the target position to the motor 232Y. Accordingly, the motor 232Y drives the tool spindle 30 to a certain position in the Y direction. The motor 232Y may be an AC motor, a stepping motor, a servo motor, or another type of motor.

The motor driver 231Z successively receives, from the control unit 50, input of a target position in the Z-axis direction of the tool spindle 30, and outputs a current corresponding to the target position to the motor 232Z. Accordingly, the motor 232Z moves the tool spindle 30 to a certain position in the Z direction. The motor 232Z may be an AC motor, a stepping motor, a servo motor, or another type of motor.

The rotation drive unit 230B is a drive mechanism for driving the tool spindle 30 to rotate about an axis orthogonal to the rotation axis CE. The rotation drive unit 230B may be constituted by a single drive unit or a plurality of drive units. In the example of FIG. 3, the rotation drive unit 230B is constituted by a motor driver 231B and a motor 232B.

The motor driver 231B sequentially receives, from the control unit 50, input of the target rotation angle or the target rotation speed of the tool spindle 30 about the Y-axis direction, and outputs a current corresponding to the target rotation angle or the target rotation speed to the motor 232B. The motor 232B drives the tool spindle 30 to rotate about the B axis, which is centered in the Y axis direction. The motor 232B may be an AC motor, a stepping motor, a servo motor, or another type of motor.

The rotation drive unit 230C is a drive mechanism for driving the tool spindle 30 to rotate about the rotation axis CE (see FIG. 2). In the example of FIG. 3, the rotation drive unit 230C is constituted by a motor driver 231C, a motor 232C, and a brake mechanism BCE.

The motor driver 231C sequentially receives, from the control unit 50, the target rotation angle or the target rotation speed of the tool spindle 30, and outputs a current corresponding to the target rotation angle or the target rotation speed to the motor 232C. The motor 232C drives the tool spindle 30 to rotate about the rotation axis CE. The motor 232C may be an AC motor, a stepping motor, a servo motor, or another type of motor.

The motor 232C is provided with the brake mechanism BCE for braking the rotation of the tool spindle 30 about the rotation axis CE. The brake mechanism BCE is, for example, an electromagnetic brake, an electromagnetic clutch, or another hardware mechanism capable of preventing the rotational driving of the motor 232C. The control unit 50 outputs a control command to the brake mechanism BCE to control clamping/unclamping of the rotation shaft of the motor 232C. As an example, the control unit 50 clamps the rotating shaft of the motor 232C by outputting an ON command to the brake mechanism BCE, and unclamps the rotating shaft of the motor 232C by outputting an OFF command to the brake mechanism BCE.

### D. Hardware Configuration of Control Unit 50

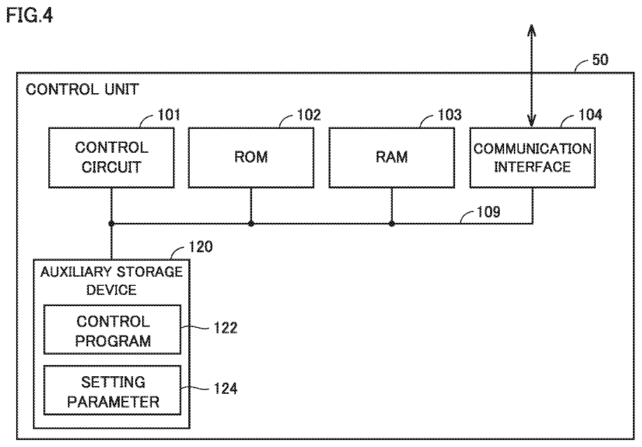

The hardware configuration of the control unit 50 shown in FIG. 3 above will be described below with reference to FIG. 4. FIG. 4 is a diagram illustrating an example of the hardware configuration of the control unit 50.

The control unit 50 includes a control circuit 101, a ROM (Read Only Memory) 102, a RAM (Random Access Memory) 103, a communication interface 104, and an auxiliary storage device 120. These components are connected to an internal bus 109.

The control circuit 101 is constituted by, for example, at least one integrated circuit. The integrated circuit may be constituted by at least one CPU, at least one GPU (Graphics Processing Unit), at least one ASIC (Application Specific Integrated Circuit), at least one FPGA (Field Programmable Gate Array), or a combination thereof, for example.

The control circuit 101 controls the operation of the control unit 50 by executing various programs such as a control program 122. Upon receiving a command to execute the control program 122, the control circuit 101 reads the control program 122 from the auxiliary storage device 120 or the ROM 102 to the RAM 103. The RAM 103 functions as a working memory and temporarily stores various types of data necessary for executing the control program 122.

The communication interface 104 is an interface for performing periodic communication with an external device using a field network. The field network is configured by adopting EtherCAT (registered trademark), EtherNet/IP (registered trademark), CC-Link (registered trademark), CompoNet (registered trademark), or the like.

The auxiliary storage device 120 is a storage medium such as a hard disk or flash memory. The auxiliary storage device 120 stores a control program 122, a setting parameter 124, and the like. The setting parameter 124 is a parameter that is referenced by the control program 122. The setting parameter 124 will be described in detail later.

Note that the storage location of the control program 122 and the setting parameter 124 is not limited to the auxiliary storage device 120, and the control program 122 and the setting parameter 124 may also be stored in a storage region (e.g., cache memory) of the control circuit 101, the ROM 102, the RAM 103, an external device (e.g., a server), or the like.

Furthermore, rather than being a standalone program, the control program 122 may be provided as part of a program. In this case, various types of processing pertaining to the present embodiment are realized in cooperation with the program. Even if the program does not include such a portion of modules, the program does not depart from the spirit of the control program 122 pertaining to the present embodiment. Furthermore, some or all of the functions provided by the control program 122 may be realized by dedicated hardware. Furthermore, the control unit 50 may be configured in a mode such as a so-called cloud service in which at least one server executes a part of the processing of the control program 122.

### E. Gear Cutting

The machine tool 100 has a function of performing gear cutting on the workpiece W in addition to milling, in which a rotating tool T is brought into contact with the workpiece W fixed to the workpiece spindle 22. A pinion cutter, which is a type of tool T, is used for gear cutting.

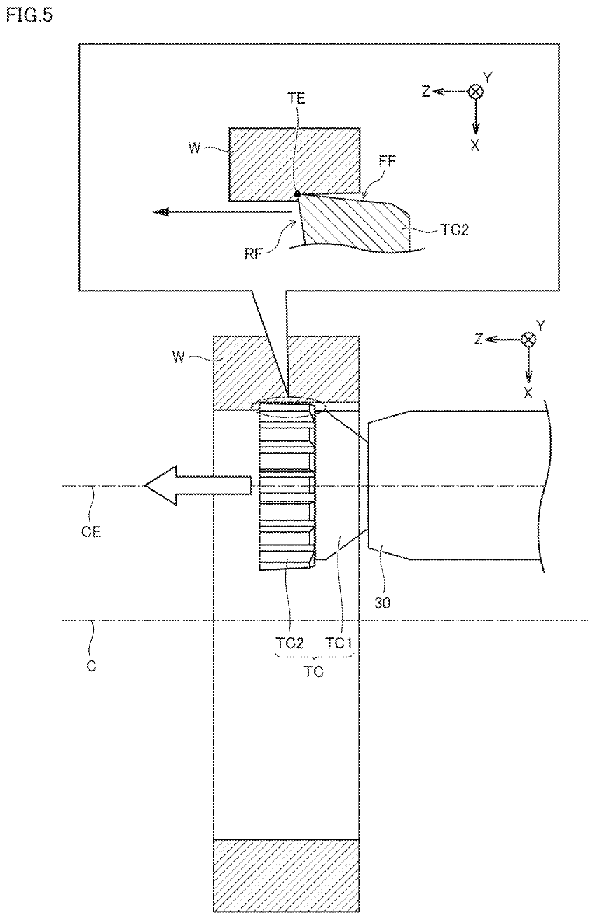

FIG. 5 is a diagram showing the pinion cutter TC performing gear cutting on the workpiece W. In the example of FIG. 5, a cross section of a cylindrical workpiece W in the YZ plane is shown, and the pinion cutter TC performs gear cutting on an inner peripheral surface of the workpiece W.

As described above, when performing gear cutting on the workpiece W, the machine tool 100 calls up the pinion cutter TC stored in the magazine 5 and attaches the pinion cutter TC to the tool spindle 30 via the ATC 6. The machine tool 100 then performs gear cutting on the inner peripheral surface of the workpiece W or the outer peripheral surface of the workpiece W by driving the tool spindle 30 to reciprocate along the rotation axis CE while keeping the rotation axis CE of the tool spindle 30 parallel to the rotation axis C of the workpiece spindle 22. Gear cutting may be performed only on an outward stroke when the tool spindle 30 is driven to reciprocate, or may be performed on both an outward stroke and a return stroke when the tool spindle 30 is driven to reciprocate.

The pinion cutter TC is constituted by a main body portion TC1 and a plurality of tooth portions TC2. The plurality of tooth portions TC2 are formed at equal intervals on the outer peripheral surface of the main body portion TC1. Each of the plurality of tooth portions TC2 has a tooth tip TE, a rake face RF, and a flank face FF.

The tooth tip TE is a portion that is pressed against the workpiece W. In other words, the tooth tip TE corresponds to a ridge line where the rake face RF and the flank face FF intersect.

Note that in the example of FIG. 5, a tooth tip TE with an acute angle is shown, but the angle of the tooth tip TE does not necessarily need to be an acute angle. Also, the tooth tip TE does not necessarily need to be sharp, and may be rounded.

The rake face RF is one of two surfaces extending from the tooth tip TE, and is the surface that comes into contact with the workpiece W in the feed drive direction of the tool spindle 30. In other words, the rake face RF is the surface along which chips from the workpiece W flow when the workpiece W is subjected to gear cutting.

The flank face FF is the other of the two surfaces extending from the tooth tip TE. That is, the flank face FF is a surface that extends from the tooth tip TE in a direction different from that of the rake face RF. The flank face FF is a surface provided to reduce unnecessary abrasion with the workpiece surface.

The machine tool 100 according to the embodiment has a C-XY mode and a C-CE mode as machining modes related to gear cutting. The following describes gear cutting in the C-XY mode and gear cutting in the C-CE mode in that order.

In the following, the term “turning” will be used, and in this specification, “turning” means rotation of the tool spindle 30 about the rotation axis C on a plane orthogonal to the rotation axis C (i.e., on the XY plane), or rotation of the tool spindle 30 about the rotation axis CE on a plane orthogonal to the rotation axis CE (i.e., on the XY plane). Note that since the workpiece spindle 22 is interlocked with the workpiece W, turning of the workpiece spindle 22 is synonymous with turning of the workpiece W. In addition, since the tool spindle 30 is interlocked with the pinion cutter TC, turning of the tool spindle 30 is synonymous with turning of the pinion cutter TC.

Furthermore, the term “revolution” will be used hereinafter, and “revolution” as used in the present specification means rotational movement of the tool spindle 30 about the rotation axis C on a plane orthogonal to the rotation axis C (i.e., on the XY plane). Note that since the tool spindle 30 is interlocked with the pinion cutter TC, revolution of the tool spindle 30 is synonymous with revolution of the pinion cutter TC. In addition, when the term “revolution” is used below, it does not necessarily mean a rotational movement over the entire circumference (one revolution) on the plane, but may also include a partial circular arc motion on the plane.

### E1. C-XY Mode

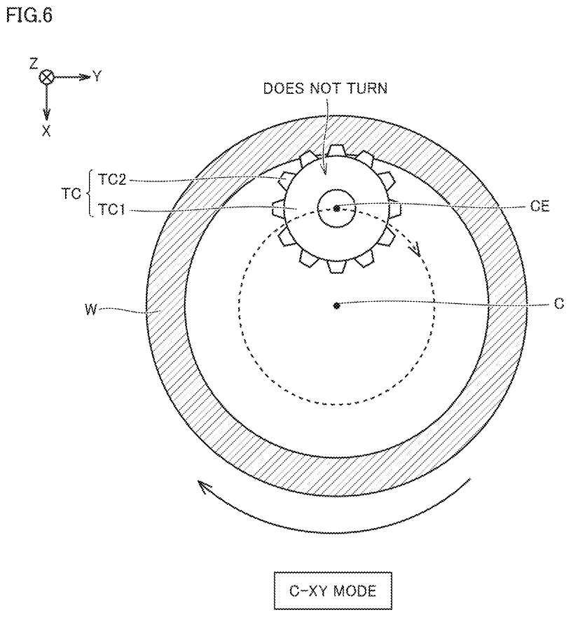

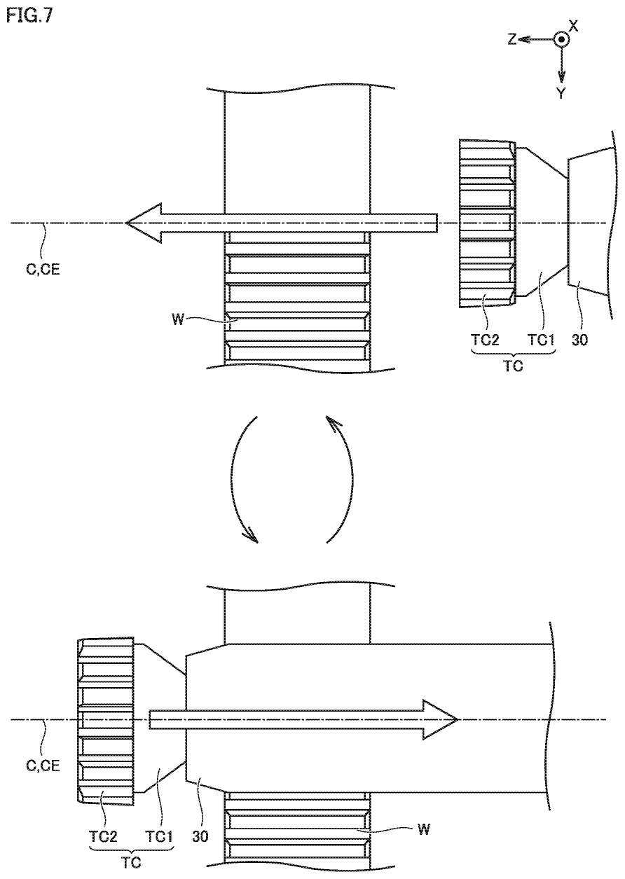

First, gear cutting in the C-XY mode will be described with reference to FIGS. 6 and 7. FIG. 6 is a diagram showing the machining mode in the C-XY mode from the Z-axis direction. FIG. 7 is a diagram showing the processing mode in the C-XY mode from the X-axis direction.

First, the machine tool 100 controls the above-described rotation drive unit 230B such that the rotation axis CE of the tool spindle 30 and the rotation axis C of the workpiece spindle 22 become parallel to each other. Next, the machine tool 100 moves the tool spindle 30 to a predetermined machining start position. The machining start position is, for example, defined in advance in the machining program.

Next, the machine tool 100 performs gear cutting on the inner peripheral surface of the workpiece W or the outer peripheral surface of the workpiece W by driving the tool spindle 30 to reciprocate along the rotation axis C while keeping the rotation axis C and the rotation axis CE parallel to each other. Hereinafter, this processing will also be referred to as “reciprocating drive processing”. In the reciprocating drive processing, the tool spindle 30 is driven to the positive side of the Z-axis direction and to the negative side of the Z-axis direction. When the tool spindle 30 is driven to the positive side of the Z-axis direction, the surface of the workpiece Wis cut. Thereafter, the machine tool 100 drives the tool spindle 30 to the negative side in the Z-axis direction while keeping a predetermined distance from the surface of the workpiece W.

Next, the machine tool 100 adjusts the position angle between the workpiece spindle 22 and the tool spindle 30. In the C-XY mode, the machine tool 100 turns the workpiece spindle 22 about the rotation axis C by a predetermined angle, and causes the tool spindle 30 to undergo a circular arc motion about the rotation axis C by a predetermined angle. The orientation of the tool spindle 30 does not change during the circular arc motion in the C-XY mode. That is, the orientation of the tool spindle 30 is maintained during the circular arc motion in the C-XY mode. Hereinafter, processing for adjusting the position angles of the workpiece spindle 22 and the tool spindle 30 will also be referred to as “angle adjustment processing”.

The machine tool 100 repeatedly executes the reciprocating drive processing and the angle adjustment processing in that order. As a result, the workpiece spindle 22 turns about the rotation axis C, and the tool spindle 30 revolves about the rotation axis C. In addition, the reciprocating drive processing and the angle adjustment processing are repeatedly executed while the above-described brake mechanism BCE is applied. That is, in the C-XY mode, gear cutting is performed while the turning of the tool spindle 30 about the rotation axis CE is prevented. As a result, gear cutting is continuously performed on the outer peripheral surface or the inner peripheral surface of the workpiece W, and the machine tool 100 can form a gear from the workpiece W.

As described above, in the C-XY mode, gear cutting of the workpiece W is realized without turning the tool spindle 30. This has the following advantages: in cutting the workpiece W, the rotation speed of the tool spindle 30 is important, and therefore the reading accuracy of the rotation angle of the tool spindle 30 is often not required to such an extent. For this reason, depending on the machine tool, the accuracy of an encoder for reading the rotation angle of the tool spindle 30 is low in some cases. In contrast, in the C-XY mode, the machine tool 100 does not turn the tool spindle 30, and is therefore not influenced by the accuracy of the encoder. As a result, the accuracy of the gear cutting is improved.

In addition, in the C-XY mode, gear cutting is performed with the brake mechanism BCE always on. This reduces the number of times the brake mechanism BCE is turned on and off, thereby shortening the machining time.

Furthermore, the machine tool 100 performs gear cutting on the workpiece W while the rotation axis CE of the tool spindle 30 is physically fixed by the brake mechanism BCE. This prevents the tool spindle 30 from rotating due to cutting resistance. For this reason, the machine tool 100 can move the tool spindle 30 at a high speed along the rotation axis CE, and can cut the workpiece W smoothly.

Note that although FIGS. 6 and 7 show an example in which the machine tool 100 performs gear cutting on the inner peripheral surface of the workpiece W, the machine tool 100 may also be configured to perform gear cutting on the outer peripheral surface of the workpiece W.

Preferably, the machine tool 100 turns on and off the brake mechanism BC associated with the rotation axis C of the workpiece spindle 22 as appropriate. More specifically, the machine tool 100 turns on the brake mechanism BC between when the angle adjustment processing is complete and when the reciprocating drive processing is started, thereby disabling the workpiece spindle 22 from turning. Thereafter, the machine tool 100 executes the reciprocating drive processing.

Next, the machine tool 100 turns off the brake mechanism BC between when the reciprocating drive processing is complete and when the angle adjustment processing is started, thereby enabling the workpiece spindle 22 to turn. Thereafter, the machine tool 100 executes the angle adjustment processing to turn the workpiece spindle 22 by a predetermined angle.

### E2. C-CE Mode

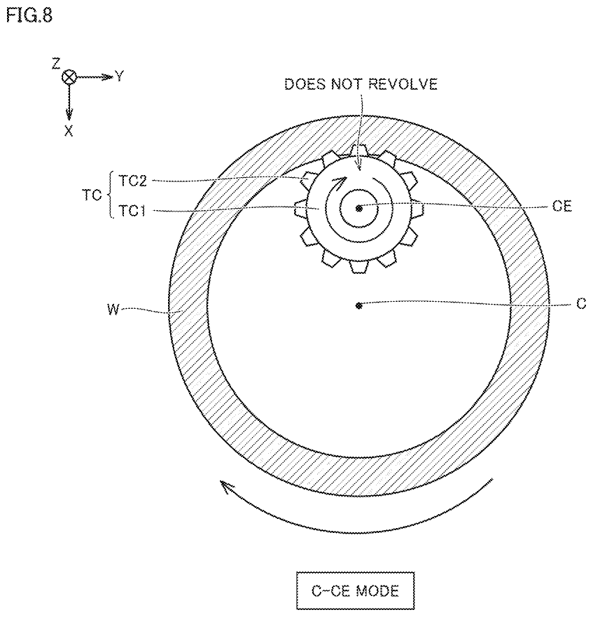

Next, gear cutting in the C-CE mode will be described with reference to FIG. 8. FIG. 8 is a diagram showing the machining mode in the C-CE mode from the Z-axis direction.

In the above-described C-XY mode, the machine tool 100 turns the workpiece spindle 22 while revolving the tool spindle 30 during angle adjustment processing. In contrast, in the C-CE mode, the machine tool 100 turns both the tool spindle 30 and the workpiece spindle 22 without revolving the tool spindle 30 during angle adjustment processing.

In addition, in the above-described C-XY mode, the machine tool 100 performs gear cutting with the brake mechanism BCE always on. On the other hand, in the C-CE mode, the machine tool 100 turns off the brake mechanism BCE during angle adjustment processing, enabling the tool spindle 30 to turn. Then, the machine tool 100 performs the reciprocating drive processing with the brake mechanism BCE turned on. In this way, in the C-CE mode, the machine tool 100 repeatedly turns the brake mechanism BCE on and off.

As more specific processing, the machine tool 100 first controls the above-described rotation drive unit 230B such that the rotation axis CE of the tool spindle 30 and the rotation axis C of the workpiece spindle 22 become parallel to each other. Next, the machine tool 100 moves the tool spindle 30 to a machining start position on the XY plane. The machining start position is defined in advance in a machining program or the like.

Next, the machine tool 100 turns on the brake mechanism BCE to prevent the tool spindle 30 from turning. Thereafter, the machine tool 100 executes processing for driving the tool spindle 30 to reciprocate along the rotation axis C while keeping the rotation axes C and CE parallel to each other (i.e., reciprocating drive processing). In the reciprocating drive processing, the tool spindle 30 is driven to the positive side of the Z-axis direction and to the negative side of the Z-axis direction. When the tool spindle 30 is driven to the positive side of the Z-axis direction, the surface of the workpiece Wis cut. Thereafter, the machine tool 100 drives the tool spindle 30 to the negative side in the Z-axis direction while keeping a predetermined distance from the surface of the workpiece W.

Next, the machine tool 100 turns off the brake mechanism BCE to enable the tool spindle 30 to turn. Thereafter, the machine tool 100 executes processing for rotating the tool spindle 30 by a predetermined angle about the rotation axis CE (i.e., angle adjustment processing).

The machine tool 100 repeatedly executes the reciprocating drive processing and the angle adjustment processing in that order. In this way, in the C-CE mode, the machine tool 100 realizes gear cutting on the workpiece W by turning both the workpiece spindle 22 and the tool spindle 30 without revolving the tool spindle 30. That is, in the C-CE mode, the position of the tool spindle 30 on the XY plane when performing gear cutting is the same or approximately the same. For this reason, the machine tool 100 can perform gear cutting on the workpiece W even when the drivable range of the tool spindle 30 on the XY plane is limited. This type of machining is particularly advantageous when performing gear cutting on the outer peripheral surface of the workpiece W.

In addition, the machine tool 100 performs gear cutting on the workpiece W while the rotation axis CE of the tool spindle 30 is physically fixed by the brake mechanism BCE. This prevents the tool spindle 30 from rotating due to cutting resistance. For this reason, the machine tool 100 can move the tool spindle 30 at a high speed along the rotation axis CE, and can cut the workpiece W smoothly.

Note that although FIG. 8 shows an example in which the machine tool 100 performs gear cutting on the inner peripheral surface of the workpiece W, the machine tool 100 may also be configured to perform gear cutting on the outer peripheral surface of the workpiece W.

Preferably, the machine tool 100 not only turns on and off the brake mechanism BCE associated with the tool spindle 30, but also turns on and off the brake mechanism BC associated with the rotation axis C of the workpiece spindle 22 as appropriate. More specifically, the machine tool 100 turns on the brake mechanisms BC and BCE between when the angle adjustment processing is completed and when the reciprocating drive processing is started, thereby disabling the workpiece spindle 22 and the tool spindle 30 from turning. Thereafter, the machine tool 100 executes the reciprocating drive processing.

Next, the machine tool 100 turns off the brake mechanisms BC and BCE between when the reciprocating drive processing is completed and when the angle adjustment processing is started, thereby enabling the workpiece spindle 22 and the tool spindle 30 to turn.

Thereafter, the machine tool 100 executes angle adjustment processing in which the workpiece spindle 22 is turned by a predetermined angle while the tool spindle 30 is turned by a predetermined angle.

### F. Temperature Monitoring Processing

Next, processing for monitoring the temperature of the machine tool 100 will be described.

As described above, the machine tool 100 performs gear cutting on the workpiece W by repeatedly performing the reciprocating drive processing and the angle adjustment processing in that order. When the tool spindle 30 is repeatedly driven to reciprocate along the rotation axis CE in the reciprocating drive processing, the temperature of the drive system associated with the tool spindle 30 rises. In view of this, the machine tool 100 monitors the temperature of the drive system associated with the tool spindle 30, and executes abnormality handling processing in a case where the temperature reaches or exceeds a predetermined temperature.

The drive system to be subjected to temperature monitoring may be, for example, the above-described motor 232Z (see FIG. 3) for driving the tool spindle 30 along the rotation axis CE, or a ball screw (not shown) driven by the motor 232Z.

Various methods can be used to detect the temperature of the drive system associated with the tool spindle 30.

As an example, the temperature of the drive system associated with the tool spindle 30 is detected using a temperature sensor (not shown). The temperature sensor is provided in the drive system to be subjected to temperature monitoring. The machine tool 100 periodically acquires the temperature detected by the temperature sensor, and executes abnormality handling processing in a case where the temperature reaches or exceeds a predetermined value.

As another example, the temperature of the drive system associated with the tool spindle 30 is estimated using a trained model that has learned the correlation between the machining conditions of the workpiece W and the temperature of the drive system associated with the tool spindle 30. The trained model is generated by predetermined machine learning processing using a training dataset. Various machine learning algorithms can be adopted as learning methods for generating the trained model. Examples of machine learning algorithms include deep learning and support vector machines.

Each piece of training data included in the training data set is associated with the machining conditions of the workpiece W as explanatory variables and the temperature of the drive system related to the tool spindle 30 as a response variable. Examples of the machining conditions that are explanatory variables include a feed rate of the tool spindle 30 at each point in time along the rotation axis CE and the number of reciprocations of the tool spindle 30 per unit time.

The machine tool 100 acquires the current machining conditions and inputs them into the trained model. As a result, the machine tool 100 acquires the temperature of the drive system associated with the tool spindle 30 from the trained model. The machine tool 100 executes abnormality handling processing in a case where the estimated temperature reaches or exceeds a predetermined value.

Note that the abnormality handling processing may include various types of processing. As an example, the abnormality handling processing includes processing for stopping the machining of the workpiece W.

As another example, the abnormality handling processing includes processing for notifying that the temperature of the drive system of the tool spindle 30 has reached or exceeded a predetermined value. The notification processing is realized, for example, by displaying a message indicating the occurrence of an abnormality on the above-described display 405 (see FIG. 1). Alternatively, the notification processing is realized by turning on an abnormality lamp (not shown) provided on the machine tool 100.

The machine tool 100 stops the execution of the abnormality handling processing in a case where the temperature of the drive system associated with the tool spindle 30 falls below a predetermined value. This causes the machine tool 100 to resume machining of the workpiece W or cancel notification of the warning.

### G. Setting Parameter 124

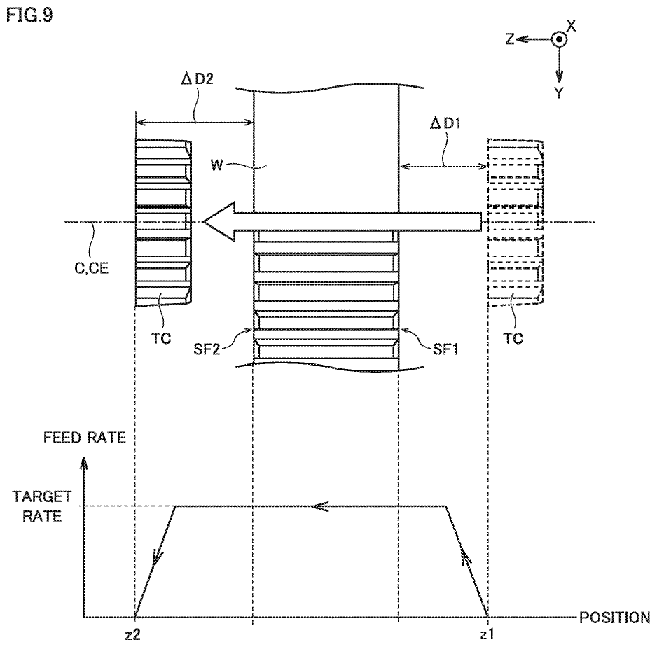

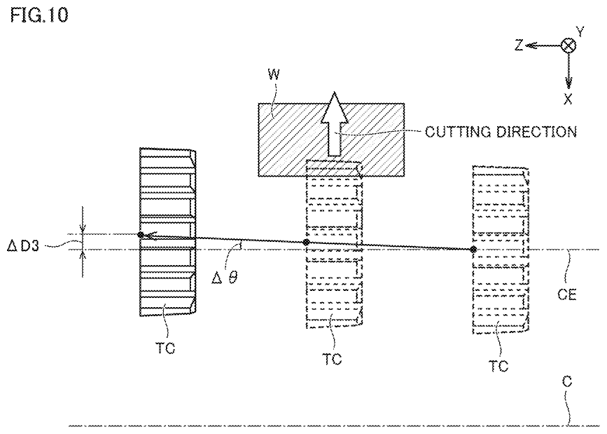

Next, the above-described setting parameter 124 (see FIG. 4) will be described with reference to FIGS. 9 and 10.

The machine tool 100 performs gear cutting in the C-XY mode or the C-CE mode according to the setting parameter 124. The setting parameter 124 may be set in advance by the user or may be set in advance when the machining program is designed.

The settable setting parameter 124 includes various parameters. Examples of the settable setting parameter 124 are described below.

### G1. Specific Example 1 of Setting Parameter 124

The setting parameter 124 includes a parameter for designating whether or not braking by the brake mechanism BCE is enabled in the C-XY mode. As described above, the brake mechanism BCE applies a brake to the rotation of the tool spindle 30 about the rotation axis CE.

When the setting parameter 124 is set to enable braking by the brake mechanism BCE, the machine tool 100 executes the reciprocating drive processing and the angle adjustment processing while enabling the braking. That is, in this case, as described in FIG. 6, the brake mechanism BCE inhibits the tool spindle 30 from turning.

On the other hand, when the setting parameter 124 is set to disable braking by the brake mechanism BCE, the machine tool 100 always keeps the brake mechanism BCE off. In this case, the machine tool 100 maintains the rotation angle of the tool spindle 30 by utilizing a holding force of the motor 232C (see FIG. 3) serving as a servo motor.

More specifically, during the reciprocating drive processing, the machine tool 100 inputs the target rotation angle of the tool spindle 30 to the motor driver 231C (see FIG. 3). The motor driver 231C calculates the actual rotation angle of the motor 232C from a feedback signal of an encoder (not shown) for detecting the rotation angle of the motor 232C. Then, the motor driver 231C controls the rotation angle of the motor 232C such that the calculated actual rotation angle approaches the target rotation angle. In this way, the motor driver 231C sequentially receives feedback of the rotation angle of the motor 232C and causes the rotation angle of the motor 232C to approach the target rotation angle. This allows the rotation angle of the motor 232C to be kept constant during the reciprocating drive processing.

As another example, the setting parameter 124 includes a parameter for designating whether or not to enable braking by the brake mechanism BC in the C-XY mode. As described above, the brake mechanism BC applies a brake to the rotation of the workpiece spindle 22 about the rotation axis C.

When the setting parameter 124 is set to enable braking by the brake mechanism BC, the machine tool 100 sequentially turns the brake mechanism BC on and off. That is, in this case, as described above, the reciprocating drive processing is executed with the brake mechanism BC in the ON state, and the angle adjustment processing is executed with the brake mechanism BC in the OFF state.

On the other hand, if the setting parameter 124 is set to disable braking by the brake mechanism BC, the machine tool 100 always keeps the brake mechanism BC off. In this case, the machine tool 100 suppresses the turning of the workpiece spindle 22 by utilizing the holding force of the motor 212C (see FIG. 3) serving as a servo motor.

Note that the holding force of the motor 212C is set for general machining in some cases. When machining in the C-XY mode with braking by the brake mechanism BC disabled, the machine tool 100 may perform machining in the C-XY mode with a holding force different from that used for general machining. The holding force is optimized by adjusting, for example, gain parameters or the like related to the control of the workpiece spindle 22. This minimizes the angle change when the workpiece spindle 22 receives a cutting load.

More specifically, during the reciprocating drive processing, the machine tool 100 inputs the target rotation angle of the workpiece spindle 22 to the motor driver 211C (see FIG. 3). The motor driver 211C calculates the actual rotation angle of the motor 212C from a feedback signal of an encoder (not shown) for detecting the rotation angle of the motor 212C. Then, the motor driver 211C controls the rotation angle of the motor 212C such that the calculated actual rotation angle approaches the target rotation angle. In this way, the motor driver 211C sequentially receives feedback of the rotation angle of the motor 212C and causes the rotation angle of the motor 212C to approach the target rotation angle. As a result, the rotation angle of the motor 212C is kept constant during the reciprocating drive processing.

### G2. Specific Example 2 of Setting Parameter 124

Next, another example of the setting parameter 124 will be described.

In this example, the setting parameter 124 includes a parameter for designating whether or not braking by the brake mechanism BCE is enabled in the C-CE mode. As described above, the brake mechanism BCE applies braking to the rotation of the tool spindle 30 about the rotation axis CE.

When the setting parameter 124 is set to enable braking by the brake mechanism BCE, the machine tool 100 sequentially turns the brake mechanism BCE on and off. That is, in this case, as described above, the reciprocating drive processing is executed with the brake mechanism BCE in an ON state, and the angle adjustment processing is executed with the brake mechanism BCE in an OFF state.

On the other hand, when the setting parameter 124 is set to disable braking by the brake mechanism BCE, the machine tool 100 always keeps the brake mechanism BCE off. In this case, the machine tool 100 suppresses rotation of tool spindle 30 by utilizing the holding force of the motor 232C (see FIG. 3) serving as a servo motor.

More specifically, during the reciprocating drive processing, the machine tool 100 inputs the target rotation angle of the tool spindle 30 to the motor driver 231C (see FIG. 3). The motor driver 231C calculates the actual rotation angle of the motor 232C from a feedback signal of an encoder (not shown) for detecting the rotation angle of the motor 232C. Then, the motor driver 231C controls the rotation angle of the motor 232C such that the calculated actual rotation angle approaches the target rotation angle. In this way, the motor driver 231C sequentially receives feedback of the rotation angle of the motor 232C and causes the rotation angle of the motor 232C to approach the target rotation angle. This allows the rotation angle of the motor 232C to be kept constant during the reciprocating drive processing.

As another example, the setting parameter 124 includes a parameter for designating whether or not to enable braking by the brake mechanism BC in the C-CE mode. As described above, the brake mechanism BC applies braking to the rotation of the workpiece spindle 22 about the rotation axis C.

When the setting parameter 124 is set to enable braking by the brake mechanism BC, the machine tool 100 sequentially turns the brake mechanism BC on and off. That is, in this case, as described above, the reciprocating drive processing is executed with the brake mechanism BC in the ON state, and the angle adjustment processing is executed with the brake mechanism BC in the OFF state.

On the other hand, if the setting parameter 124 is set to disable braking by the brake mechanism BC, the machine tool 100 always keeps the brake mechanism BC off. In this case, the machine tool 100 suppresses the turning of the workpiece spindle 22 by utilizing the holding force of the motor 212C (see FIG. 3) serving as a servo motor.

More specifically, during the reciprocating drive processing, the machine tool 100 inputs the target rotation angle of the workpiece spindle 22 to the motor driver 211C (see FIG. 3). The motor driver 211C calculates the actual rotation angle of the motor 212C from a feedback signal of an encoder (not shown) for detecting the rotation angle of the motor 212C. Then, the motor driver 211C controls the rotation angle of the motor 212C such that the calculated actual rotation angle approaches the target rotation angle. In this way, the motor driver 211C sequentially receives feedback of the rotation angle of the motor 212C and causes the rotation angle of the motor 212C to approach the target rotation angle. As a result, the rotation angle of the motor 212C is kept constant during the reciprocating drive processing.

### G3. Example 3 of Setting Parameter 124

Next, with reference to FIG. 9, a further example of the setting parameter 124 will be described. FIG. 9 is a diagram for describing the reciprocating drive processing of the tool spindle 30 during gear cutting. Note that in FIG. 9, the tool spindle 30 is omitted, and only the pinion cutter TC is shown.

During the reciprocating drive processing, the tool spindle 30 is driven to reciprocate between a position “z1” (first position) along the rotation axis C and a position “z2” (second position) along the rotation axis C. The position “z1” is a position that is a predetermined distance ΔD1 (first distance) away from a surface SF1 on one side of the workpiece W along the rotation axis C. The position “z2” is a position that is a predetermined distance ΔD2 (second distance) away from a surface SF2 on the other side of the workpiece W along the rotation axis C.

In order to stabilize gear cutting, the machine tool 100 needs to keep the feed rate of the pinion cutter TC constant at a target rate while the pinion cutter TC is cutting the workpiece W. Meanwhile, the feed rate of the tool spindle 30 gradually changes toward the target rate.

In view of this, the machine tool 100 sets the position “z1” that is the predetermined distance ΔD1 away from the surface SF1 on one side of the workpiece W along the rotation axis C as the start point of the reciprocating drive processing. The predetermined distance ΔD1 indicates the distance in the Z-axis direction between the surface SF1 of the workpiece and the tooth tip of the pinion cutter TC. The above-described setting parameter 124 includes the predetermined distance ΔD1. The predetermined distance ΔD1 is, for example, several mm to several cm.

In addition, the machine tool 100 sets the position “z2” that is the predetermined distance ΔD2 away from the surface SF2 on the other side of the workpiece W along the rotation axis C as the end point of the reciprocating drive processing. The predetermined distance ΔD2 indicates the distance in the Z-axis direction between the surface SF2 of the workpiece and the tooth tip of the pinion cutter TC. The above-described setting parameter 124 includes the predetermined distance ΔD2. The predetermined distance ΔD2 is, for example, several mm to several cm. The predetermined distance ΔD2 may be the same as the predetermined distance ΔD1, or may be different from the predetermined distance ΔD1.

By providing the predetermined distance ΔD1 as a run-up distance, the machine tool 100 can set the feed rate of the tool spindle 30 to the target rate before contact with the workpiece W. On the other hand, by providing the predetermined distance ΔD2, the machine tool 100 can prevent the feed rate of the tool spindle 30 from being reduced before the pinion cutter TC has cleared the workpiece W.

Note that the distances ΔD1 and ΔD2 may be the setting parameter 124 referenced in the above-described C-XY mode, or may be the setting parameter 124 referenced in the above-described C-CE mode.

In addition, in the above description, the distances ΔD1 and ΔD2 have been described as an example of the setting parameter 124, but the positions “z1” and “z2” may also be set as the setting parameter 124.

### G4. Specific Example 4 of Setting Parameter 124

Next, another example of the setting parameter 124 will be described.

As described in FIG. 6, in the C-XY mode, the tool spindle 30 is driven to revolve about the rotation axis C. At this time, the center coordinates of the workpiece W are shifted due to thermal displacement or the like in some cases. In view of this, the setting parameter 124 includes a correction value related to the center of revolution of the tool spindle 30 during the angle adjustment processing.

The machine tool 100 corrects the center of rotation on the XY plane based on the correction value, and controls the above-described feed drive unit 230A (see FIG. 3) such that the tool spindle 30 revolves about the corrected center.

As an example, the above-described correction value includes an offset value “ΔX” in the X-axis direction and an offset value “ΔY” in the Y-axis direction. In this case, the center of rotation in the X-axis direction is shifted by “ΔX” from a preset value, and the center of rotation in the Y-axis direction is shifted by “ΔY” from a preset value.

### G5. Specific Example 5 of Setting Parameter 124

Next, with reference to FIG. 10, a further example of the setting parameter 124 will be described. FIG. 10 is a diagram showing a state in which the pinion cutter TC is feed-driven obliquely.

As described above, in the reciprocating drive processing in the C-XY mode and the C-CE mode, the machine tool 100 drives the tool spindle 30 to reciprocate with the rotation axis C and the rotation axis CE parallel to each other. At this time, the pinion cutter TC receives cutting resistance from the surface of the workpiece W. The cutting resistance is a force that the pinion cutter TC receives when cutting the workpiece W. If the pinion cutter TC is feed-driven while receiving the cutting resistance, the path of the pinion cutter TC may shift from the intended path.

In this case, the path of the pinion cutter TC is shifted in the direction opposite to a cutting direction of cutting into the workpiece W. The cutting direction is a direction from the rotation axes C and CE toward the contact point between the workpiece W and the pinion cutter TC on a plane orthogonal to the rotation axes C and CE (i.e., on the XY plane). In other words, the cutting direction is a direction from the rotation axis C toward the rotation axis CE on a plane orthogonal to the rotation axes C and CE (i.e., on the XY plane).

The path of the pinion cutter TC may shift in the direction opposite to the cutting direction during the reciprocating drive processing. In view of this, the setting parameter 124 includes a parameter for designating whether or not the feed drive direction of the tool spindle 30 when cutting the workpiece W is to be inclined in the cutting direction of the workpiece W.

Preferably, the parameter designates the degree to which the workpiece W is inclined in the cutting direction. This degree is designated by, for example, an inclination angle Δθ or a distance ΔD3 shown in FIG. 10.

The inclination angle Δθ is an inclination angle based on the rotation axes C and CE. When the machine tool 100 drives the tool spindle 30 in the reciprocating drive processing, the feed drive direction is inclined by the designated inclination angle Δθ. Note that when the inclination angle 40 is set to zero, the machine tool 100 drives the tool spindle 30 along the rotation axes C and CE.

The distance ΔD3 corresponds to the width by which the tool spindle 30 is shifted in the cutting direction when the tool spindle 30 is feed-driven from the above-described position “z1” (see FIG. 9) to the above-described position “z2” (see FIG. 9). Note that when the distance ΔD3 is set to zero, the machine tool 100 drives the tool spindle 30 along the rotation axes C and CE.

### H. Control Flow in C-XY Mode

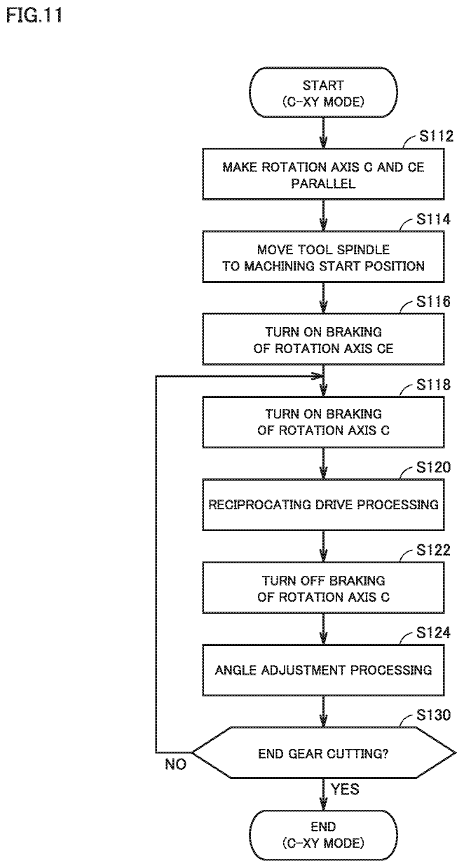

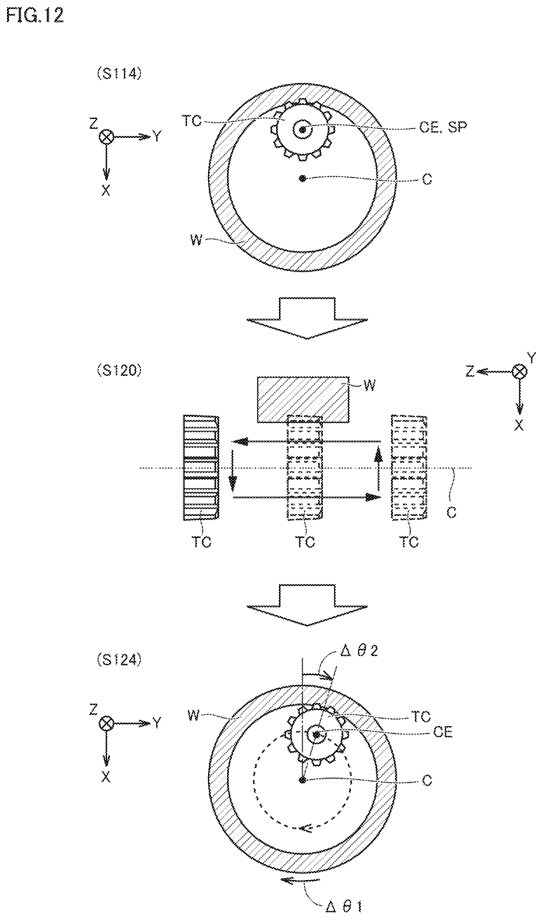

Next, the control flow in the C-XY mode will be described with reference to FIGS. 11 and 12. FIG. 11 is a flowchart showing a flow of machining processing in the above-described C-XY mode. FIG. 12 is a diagram schematically showing a flow of the machining mode in the C-XY mode.

The processing shown in FIGS. 11 and 12 is realized, for example, by the control unit 50 of the machine tool 100 executing the above-described control program 122. In another aspect, some or all of the processing may be executed by circuit elements or other hardware.

In step S112, the control unit 50 controls the above-described rotation drive unit 230B such that the rotation axis C of the workpiece spindle 22 and the rotation axis CE of the tool spindle 30 are parallel to each other.

In step S114, the control unit 50 controls the feed drive unit 230A so as to drive the tool spindle 30 to a predetermined machining start position SP on the XY plane.

The machining start position SP is defined in advance in a program such as the control program 122. The machining start position SP is defined, for example, such that the tooth tip of the pinion cutter TC overlaps with the machining surface of the workpiece W in a view from the direction of the rotation axis C or the rotation axis CE.

In step S116, the control unit 50 turns on the above-described brake mechanism BCE (see FIG. 3), and locks the rotation axis CE of the tool spindle 30. As a result, the tool spindle 30 is unable to turn.

In step S118, the control unit 50 turns on the above-described brake mechanism BC (see FIG. 3), and locks the rotation axis C of the workpiece spindle 22. As a result, the workpiece spindle 22 is unable to turn.

In step S120, the control unit 50 controls the feed drive unit 230A to drive the tool spindle 30 to reciprocate along the rotation axis C while the rotation axis C and the rotation axis CE are kept parallel to each other. More specifically, first, the control unit 50 drives the tool spindle 30 in the positive direction of the Z axis to perform gear cutting on the surface of the workpiece W. Thereafter, the control unit 50 moves the tool spindle 30 in the direction opposite to the cutting direction of cutting into the workpiece W. As a result, the control unit 50 retracts the pinion cutter TC from the surface of the workpiece. Thereafter, the control unit 50 drives the tool spindle 30 to the negative side in the Z-axis direction while keeping a predetermined distance from the surface of the workpiece W. Thereafter, the control unit 50 drives the tool spindle 30 in the cutting direction of the workpiece W by the distance that the tool spindle 30 has been retracted. As a result, the control unit 50 returns the tool spindle 30 to the start position of the reciprocating drive processing.

In step S122, the control unit 50 turns off the above-described brake mechanism BC (see FIG. 3), and releases the lock on the rotation axis C of the workpiece spindle 22. As a result, the workpiece spindle 22 is able to turn.

In step S124, the control unit 50 turns the workpiece spindle 22 about the rotation axis C by a predetermined angle “Δθ1”, and rotates the tool spindle 30 about the rotation axis C by a predetermined angle “Δθ2”. At this time, the rotation direction of the workpiece spindle 22 is the same as the rotation direction of the tool spindle 30.

Note that in the machining for forming a gear on the inner peripheral surface of the workpiece W, the rotation angle “Δθ1” of the workpiece spindle 22 and the revolution angle “Δθ2” of the tool spindle 30 are synchronized based on the following formula (1).

$$Δθ1 = Δθ 2 \cdot ( 1 - Nc / Nw ) \qquad ( 1 )$$

“Nc” in the above formula (1) represents the number of teeth of the pinion cutter TC. “Nw” in the above formula (1) indicates the number of teeth to be formed on the inner peripheral surface of the workpiece W. “Nc” and “Nw” are fixed values, and are defined in the setting parameter 124 described above, for example.

In addition, in machining for forming a gear on the outer peripheral surface of the workpiece W, the turn angle “Δθ1” of the workpiece spindle 22 and the revolution angle “Δθ2” of the tool spindle 30 are synchronized based on the following formula (2).

$$Δθ1 = Δθ 2 \cdot ( 1 + Nc / Nw ) \qquad ( 2 )$$

“Nc” in the above formula (2) represents the number of teeth of the pinion cutter TC. “Nw” in the above formula (2) indicates the number of teeth to be formed on the outer peripheral surface of the workpiece W. “Nc” and “Nw” are fixed values, and are defined in the setting parameter 124 described above, for example.

In step S130, the control unit 50 determines whether or not to end the gear cutting in the C-CX mode. As an example, the control unit 50 determines that the gear cutting in the C-CX mode is to be ended in a case where the tool spindle 30 has revolved about the rotation axis Conce. Alternatively, the control unit 50 determines that the gear cutting in the C-CX mode is to be ended in a case where the workpiece spindle 22 turns once. When the control unit 50 determines that the gear cutting in the C-CX mode is to be ended (YES in step S130), the control unit 50 ends the processing shown in FIG. 11. If not (NO in step S130), the control unit 50 returns the control to step S118.

### I. Control Flow in C-CE Mode

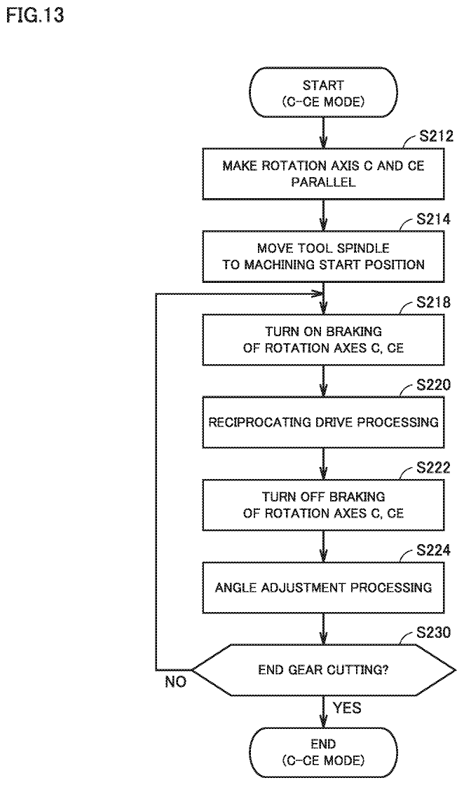

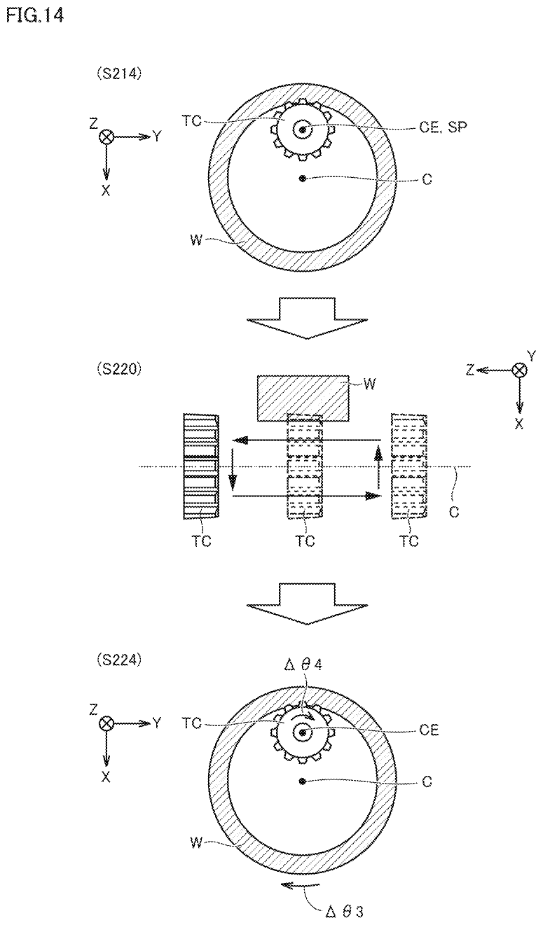

Next, the control flow in the C-CE mode will be described with reference to FIGS. 13 and 14. FIG. 13 is a flowchart showing the flow of the processing in the C-CE mode described above. FIG. 14 is a diagram showing a schematic flow of the machining mode in the C-CE mode.

The processing shown in FIGS. 13 and 14 is realized, for example, by the control unit 50 of the machine tool 100 executing the control program 122 described above. In another aspect, some or all of the processing may be executed by circuit elements or other hardware.

In step S212, the control unit 50 controls the above-described rotation drive unit 230B such that the rotation axis C of the workpiece spindle 22 and the rotation axis CE of the tool spindle 30 are parallel to each other.

In step S214, the control unit 50 controls the feed drive unit 230A to drive the tool spindle 30 to a predetermined machining start position SP on the XY plane. The machining start position SP is defined in advance in a program such as the control program 122. The machining start position SP is defined, for example, such that the tooth tip of the pinion cutter TC overlaps with the machining surface of the workpiece W in a view from the direction of the rotation axis C or the rotation axis CE.

In step S218, the control unit 50 turns on the above-described brake mechanism BC (see FIG. 3), and locks the rotation axis C of the workpiece spindle 22. As a result, the workpiece spindle 22 is unable to turn. In addition, the control unit 50 turns on the brake mechanism BCE (see FIG. 3) described above, and locks the rotation axis CE of the tool spindle 30. As a result, the tool spindle 30 is unable to turn.

In step S220, the control unit 50 controls the feed drive unit 230A to drive the tool spindle 30 to reciprocate along the rotation axis C while the rotation axis C and the rotation axis CE are kept parallel to each other. More specifically, first, the control unit 50 drives the tool spindle 30 in the positive direction of the Z axis to perform gear cutting on the surface of the workpiece W. Thereafter, the control unit 50 moves the tool spindle 30 in the direction opposite to the cutting direction of cutting into the workpiece W. As a result, the control unit 50 retracts the pinion cutter TC from the surface of the workpiece. Thereafter, the control unit 50 drives the tool spindle 30 to the negative side in the Z-axis direction while keeping a predetermined distance from the surface of the workpiece W. Thereafter, the control unit 50 drives the tool spindle 30 in the cutting direction of the workpiece W by the distance that the tool spindle 30 has been retracted. As a result, the control unit 50 returns the tool spindle 30 to the start position of the reciprocating drive processing.

In step S222, the control unit 50 turns off the brake mechanism BC (see FIG. 3) described above, and releases the lock on the rotation axis C of the workpiece spindle 22. As a result, the workpiece spindle 22 is able to turn. In addition, the control unit 50 turns off the brake mechanism BCE (see FIG. 3) described above, and releases the lock on the tool spindle 30 relative to the rotation axis CE. As a result, the tool spindle 30 is able to turn.

In step S224, the control unit 50 turns the workpiece spindle 22 about the rotation axis C by a predetermined angle “Δθ3”, and also turns the tool spindle 30 about the rotation axis C by a predetermined angle “Δθ4”. The turning direction of the workpiece spindle 22 is the same as the turning direction of the tool spindle 30.

Note that the rotation angle “Δθ3” of the workpiece spindle 22 and the rotation angle “Δθ4” of the tool spindle 30 are synchronized based on the following formula (3).

$$Δθ3 = Δθ 4 \cdot Nc / Nw \qquad ( 3 )$$

“Nc” shown in the above formula (3) indicates the number of teeth of the pinion cutter TC. “Nw” indicates the number of teeth to be formed on the surface of the workpiece W. “Nc” and “Nw” are fixed values, and are defined in the setting parameter 124 described above, for example. Note that (3) above can be applied to both the case where gear cutting is performed on the inner peripheral surface of the workpiece W and the case where gear cutting is performed on the outer peripheral surface of the workpiece W.

In step S230, the control unit 50 determines whether or not to end the gear cutting processing in the C-CE mode. As an example, the control unit 50 determines that the gear cutting in the C-CE mode is to be ended in a case where the workpiece spindle 22 turns once. When the control unit 50 determines that the gear cutting processing in the C-CE mode is to be ended (YES in step S230), the control unit 50 ends the processing shown in FIG. 13. If not (NO in step S230), the control returns to step S218.

### J. Modified Examples

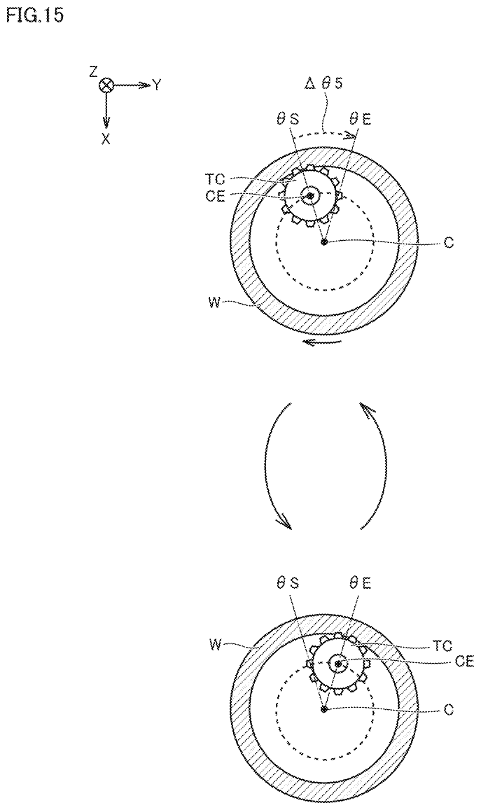

Next, a modified example of the machining mode in the above-described C-XY mode will be described with reference to FIG. 15. FIG. 15 is a diagram showing a machining mode in the C-XY mode according to the modified example, in a view from the Z-axis direction.

In the above-described C-XY mode, the machine tool 100 turns the workpiece spindle 22 while revolving the tool spindle 30 once in the angle adjustment processing. In contrast to this, in the C-XY mode according to the present modified example, the machine tool 100 turns the workpiece spindle 22 while repeatedly performing a circular arc motion of the tool spindle 30 in the angle adjustment processing.

More specifically, the machine tool 100 changes the rotation angle of the tool spindle 30 about the rotation axis C from a rotation angle θS (first rotation angle) in increments of a predetermined angle. Then, the machine tool 100 returns the rotation angle to the rotation angle θS in a case where the rotation angle reaches a rotation angle θE (second rotation angle). In this way, the machine tool 100 repeats circular arc motion of the tool spindle 30 between the rotation angle θS and the rotation angle θE.

The rotation angles θS and θE may be set by the user as appropriate, or may be defined at the time of design or the like. The rotation angles θS and θE are defined in the setting parameter 124, for example.

Note that although FIG. 15 shows an example of performing gear cutting on the inner peripheral surface of the workpiece W, the angle adjustment processing of this modified example can also be applied to the case where gear cutting is performed on the outer peripheral surface of the workpiece W.

The machine tool 100 can narrow the drivable range of the tool spindle 30 by performing gear cutting while repeating the circular arc motion of the tool spindle 30 between the rotation angles θS and OE. For this reason, even if the drivable range of the tool spindle 30 is limited, gear cutting of the workpiece W can be performed. This type of machining is particularly advantageous when performing gear cutting on the outer peripheral surface of the workpiece W.

In the following, a rotation angle between the rotation angle θS and the rotation angle θE is denoted as “Δθ5”. In the machining for forming a gear on the inner peripheral surface of the workpiece W, the rotation angle “Δθ5” is determined in advance based on the following formula (4).

$$Δθ5 = ( 360 / Nw ) \cdot ( 1 + Nc / Nw ) \qquad ( 4 )$$

“Nc” in equation (4) above represents the number of teeth of the pinion cutter TC. “Nw” in the above formula (4) indicates the number of teeth to be formed on the inner peripheral surface of the workpiece W. “Nc” and “Nw” are fixed values, and are defined in the setting parameter 124 described above, for example.

Also, in the machining for forming a gear on the outer peripheral surface of the workpiece W, the rotation angle “Δθ5” is set in advance based on the following formula (5).

$$Δθ5 = ( 360 / Nw ) \cdot ( 1 - Nc / Nw ) \qquad ( 5 )$$

“Nc” shown in the above formula (5) represents the number of teeth of the pinion cutter TC. “Nw” in the above formula (5) indicates the number of teeth to be formed on the outer peripheral surface of the workpiece W. “Nc” and “Nw” are fixed values, and are defined in the setting parameter 124 described above, for example.

Note that when returning the tool spindle 30 from the rotation angle θE to the rotation angle θS, the machine tool 100 may keep the turning of the tool spindle 30 inhibited, or may turn the tool spindle 30 by a predetermined angle. Preferably, the machine tool 100 turns the tool spindle 30 by a predetermined angle when returning the tool spindle 30 from the rotation angle θE to the rotation angle θS. This can prevent the wearing of the pinion cutter TC from being concentrated in one part.

More specifically, each time the machine tool 100 executes the angle adjustment processing, the machine tool 100 changes the rotation angle of the tool spindle 30 about the rotation axis C from the rotation angle θS by a predetermined angle. Then, in a case where the rotation angle reaches the rotation angle θE, the machine tool 100 turns off the above-described brake mechanism BCE (see FIG. 3) and releases the lock on the rotation axis CE of the tool spindle 30. Next, the machine tool 100 returns the rotation angle of the tool spindle 30 to the rotation angle θS, and rotates the tool spindle 30 by a predetermined angle about the rotation axis CE. Thereafter, the machine tool 100 turns on the brake mechanism BCE to lock the rotation axis CE of the tool spindle 30.

In the following description, the rotation angle of the tool spindle 30 when returning from the rotation angle θE to the rotation angle θS is denoted as “Δθ6”. In the machining for forming a gear on the inner peripheral surface of the workpiece W, the rotation angle “Δθ6” is determined in advance based on the following formula (6).

$$Δθ6 = 360 / Nc \qquad ( 6 )$$

Note that when the tool spindle 30 is turned by the angle “Δθ6” after one loop, the resolution of the encoder for the rotation axis CE has an influence. For this reason, preferably, the machine tool 100 calculates a turn angle “Δθ7” such that it is a multiple of the minimum resolution of the encoder. Then, the machine tool 100 reflects the difference between the calculated turn angle “Δθ7” and the above rotation angle “Δθ6” in the arc motion of the tool spindle 30 and the turning motion of the workpiece spindle 22.

In addition, the brake mechanism BCE can only clamp the tool spindle 30 at a predetermined angle (e.g., 7.5 degrees). In this case, the machine tool 100 calculates a turn angle “Δθ8” such that it is a multiple of the predetermined angle. Then, the machine tool 100 reflects the difference between the calculated turn angle “Δθ8” and the above turn angle “Δθ6” in the arc motion of the tool spindle 30 and the turning motion of the workpiece spindle 22.

### K. Other

Note that the machining mode implemented in the machine tool 100 may be either the C-XY mode or the C-CE mode, or may be both the C-XY mode and the C-CE mode.

When both the C-XY mode and the C-CE mode are implemented in the machine tool 100, the machining mode can be switched by a user operation as appropriate.

In addition, the machine tool 100 may switch between the machining mode in the above-described C-XY mode and the machining mode in the above-described C-CE mode based on a predetermined condition.

As an example, the machine tool 100 switches the operation mode depending on the diameter of the workpiece W in the direction perpendicular to rotation axis C of the workpiece spindle 22. In this case, if the diameter of the workpiece W is larger than a predetermined value, the machine tool 100 performs machining of the workpiece W in the machining mode of the C-CE mode. On the other hand, if the diameter of the workpiece W is smaller than a predetermined value, the machine tool 100 performs machining of the workpiece W in the machining mode of the C-CX mode.

Furthermore, in the above description, the tool spindle 30 is described as an example of the tool holding portion 20, but the tool holding portion 20 is not limited to the tool spindle 30. As another example, the tool holding portion 20 may be a turret. The turret is configured to be pivotable about a rotation axis (hereinafter also referred to as “rotation axis CE′”) that is parallel to the rotation axis C. The turret holds a plurality of tools spaced apart in the peripheral direction about the rotation axis CE′. Typically, the turret performs turning by bringing a fixed tool held by the turret into contact with the workpiece W that is driven to rotate by the workpiece spindle 22.

Also, the tools held by the turret include the pinion cutter TC described above. This turret can perform not only turning but also gear cutting using the pinion cutter TC.

More specifically, the turret is configured to be capable of being feed-driven in each of the X-axis to Z-axis directions by various driving mechanisms such as a motor. The turret is feed-driven along the rotation axis CE′ with the pinion cutter TC facing the rotation axis CE′, thereby realizing the gear cutting described above. Even with a machine tool including this kind of turret, machining in the above-described C-XY mode and machining in the C-CE mode can be realized.

The embodiments disclosed herein are to be considered illustrative in all respects and not restrictive. The scope of the present invention is defined not by the above description but by the claims, and all modifications within the meaning and scope equivalent to the claims are intended to be encompassed therein.

### LIST OF REFERENCE NUMERALS

5 Magazine, 11 Bed, 20 Tool holding portion, 22 Workpiece spindle, 23 First chuck mechanism, 27 Opposing workpiece spindle, 28 Second chuck mechanism, 30 Tool spindle, 50 Control unit, 100 Machine tool, 101 Control circuit, 102 ROM, 103 RAM, 104 Communication interface, 109 Internal bus, 120 Auxiliary storage device, 122 Control program, 124 Setting parameter, 130 Cover, 210 Rotation drive unit, 211C Motor driver, 212C Motor, 220 Feed drive unit, 221Z Motor driver, 222Z Motor, 230A Feed drive unit, 230B Rotation drive unit, 230C Rotation drive unit, 231B Motor driver, 231C Motor driver, 231X Motor driver, 231Y Motor driver, 231Z Motor driver, 232B Motor, 232C Motor, 232X Motor, 232Y Motor, 232Z Motor, 400 Operation panel, 405 Display, 406 Operation key, AR1 Tool storage area, AR2 Machining area, BC Brake mechanism, BCE Brake mechanism, C Rotation axis, CE Rotation axis, D Door, FF Flank face, RF Rake face, SF1 Surface, SF2 Surface, SP Machining start position, T Tool, TC Pinion cutter, TC1 Main body portion, TC2 Tooth portion, TE Tooth tip, W Workpiece, θE Rotation angle, θS Rotation angle.

1. A machine tool comprising:
a workpiece spindle configured to hold a workpiece;
a tool holding portion configured to hold a pinion cutter;
a first rotation drive unit configured to drive the workpiece spindle to rotate about a first axis extending along an axial direction of the workpiece spindle;
a feed drive unit configured to move the tool holding portion;
a second rotation drive unit configured to drive the tool holding portion to rotate about a second axis extending along an axial direction of the pinion cutter;
a first brake mechanism configured to brake rotation of the workpiece spindle;
a second brake mechanism configured to brake rotation of the tool holding portion; and
a control unit configured to control the feed drive unit, the first and second rotation drive units, and the first and second brake mechanisms,
the control unit being configured to execute
reciprocating drive processing for performing gear cutting on an inner peripheral surface or an outer peripheral surface of the workpiece by driving the tool holding portion to reciprocate along the first axis, and
adjustment processing for adjusting a rotation angle between the workpiece spindle and the tool holding portion by rotating the workpiece spindle by a predetermined angle about the first axis and rotating the tool holding portion by a predetermined angle about the second axis,
wherein the reciprocating drive processing is executed while braking by the first brake mechanism and braking by the second brake mechanism are applied, and
the adjustment processing is executed while neither braking by the first brake mechanism nor braking by the second brake mechanism is applied.

2. The machine tool according to claim 1,
wherein the control unit monitors a temperature of a drive system associated with the feed drive unit, and executes abnormality handling processing if the temperature exceeds a second threshold value.

3. The machine tool according to claim 2,
wherein the abnormality handling processing includes at least one of processing for stopping gear cutting of the workpiece and processing for outputting a warning.

4. The machine tool according to claim 2,
wherein the control unit executes processing for stopping execution of the abnormality handling processing in a case where the temperature falls below a first threshold value.

5. The machine tool according to claim 1,
wherein the control unit executes the reciprocating drive processing and the adjustment processing further based on a preset parameter,
the parameter includes a parameter for designating whether or not braking by the first brake mechanism is enabled,
if the parameter is set to enable braking by the first brake mechanism, the control unit executes the reciprocating drive processing while enabling the braking, and
if the parameter is set to disable braking by the first brake mechanism, the control unit executes the reciprocating drive processing while maintaining a rotation angle of the workpiece spindle at a target rotation angle corresponding to a command value with the braking disabled.

6. The machine tool according to claim 1,
wherein in the reciprocating drive processing, the tool holding portion is driven to reciprocate between a first position along the first axis and a second position along the first axis,
the first position is a position that is a first distance away from a surface on one side of the workpiece along the first axis, and
the second position is a position that is a second distance away from a surface on another side of the workpiece along the first axis.

7. The machine tool according to claim 6,
wherein the control unit executes the reciprocating drive processing further based on a preset parameter, and
the parameter includes the first distance and the second distance.

8. The machine tool according to claim 1,
wherein the control unit executes the adjustment processing further based on a preset parameter, and
the parameter includes a correction value associated with a rotation center of the tool holding portion during the adjustment processing.

9. The machine tool according to claim 1,
wherein the control unit executes the reciprocating drive processing further based on a preset parameter, and
the parameter includes a parameter for designating whether or not a feed drive direction of the tool holding portion during gear cutting of the workpiece is to be inclined in a cutting direction of cutting into the workpiece.

10. A control method for a machine tool,
the machine tool including:
a workpiece spindle configured to hold a workpiece;
a tool holding portion configured to hold a pinion cutter;
a first rotation drive unit configured to drive the workpiece spindle to rotate about a first axis extending along an axial direction of the workpiece spindle;
a feed drive unit configured to move the tool holding portion;
a second rotation drive unit configured to drive the tool holding portion to rotate about a second axis extending along an axial direction of the pinion cutter;
a first brake mechanism configured to brake rotation of the workpiece spindle;
a second brake mechanism configured to brake rotation of the tool holding portion; and
a control unit configured to control the feed drive unit, the first and second rotation drive units, and the first and second brake mechanisms,
the control method comprising causing the control unit to execute:
a reciprocating driving step of driving the tool holding portion to reciprocate along the first axis to perform gear cutting on an inner peripheral surface of the workpiece or an outer peripheral surface of the workpiece; and
an adjusting step of adjusting a rotation angle between the workpiece spindle and the tool holding portion by rotating the workpiece spindle by a predetermined angle about the first axis and rotating the tool holding portion by a predetermined angle about the second axis,
wherein the reciprocating driving step is executed while braking by the first brake mechanism and braking by the second brake mechanism are applied, and
the adjusting step is executed while neither braking by the first brake mechanism nor braking by the second brake mechanism is applied.

11. A non-transitory recording medium storing a control program for a machine tool,
the machine tool including:
a workpiece spindle configured to be able to hold a workpiece;
a tool holding portion configured to hold a pinion cutter;
a first rotation drive unit configured to drive the workpiece spindle to rotate about a first axis extending along an axial direction of the workpiece spindle;
a feed drive unit configured to move the tool holding portion;
a second rotation drive unit configured to drive the tool holding portion to rotate about a second axis extending along an axial direction of the pinion cutter;
a first brake mechanism configured to brake rotation of the workpiece spindle;
a second brake mechanism configured to brake rotation of the tool holding portion; and
a control unit configured to control the feed drive unit, the first and second rotation drive units, and the first and second brake mechanisms,
the control program causing the control unit to execute:
reciprocating drive processing for performing gear cutting on an inner peripheral surface or an outer peripheral surface of the workpiece by driving the tool holding portion to reciprocate along the first axis, and
adjustment processing for adjusting a rotation angle between the workpiece spindle and the tool holding portion by rotating the workpiece spindle by a predetermined angle about the first axis and rotating the tool holding portion by a predetermined angle about the second axis,
wherein the reciprocating drive processing is executed while braking by the first brake mechanism and braking by the second brake mechanism are applied, and
the adjustment processing is executed while neither braking by the first brake mechanism nor braking by the second brake mechanism is applied.
